(19) United States
(12) Patent Application Publication
(10) Pub. No.: US 2010/0181232 A1
(43) Pub. Date: Jul. 22, 2010

(54) Method and Identification of Items to be Laundered and Placed into Designated Location

(76) Inventor: Aida Z. Amsel, Morton Grove, IL (US)

Correspondence Address: EDELSON IP LAW GROUP, LTD., PO BOX 230, DEERFIELD, IL, 60015, US

(21) Appl. No.: 12/328,767

(22) Filed: Jan. 21, 2009

(51) Int. Cl. B07C 5/02

(52) U.S. Cl. 209/3.3

(57) ABSTRACT

The present invention is for a system of allowing a user to launder items so when the cleaning and drying process is complete the user may place the laundry items in their desired location by use of the kit provided. The user may repeat the process continually over time to save effort and money in sorting the laundered items and having them ready to conveniently place them in the desired location for the user's access.

The kit provides for a system of labels, which can be attached to the different containers and provides for the coding of such labels such that easy identification of the items laundered is readily ascertainable. The tags provided in the kit that are attached to the containers. The tags provided provide a method for users that are color blind or totally sightless to identify the laundered items including the colors of the laundered items for easy coordination by the user.

The items in the kit may be used in any common washer or dryer since the items do not create any mechanical issues for the machines. Further, the containers are made out of material such that the temperature of the water or the detergent, bleach or other additives to the wash will not affect the containers holding the laundered items.

### BACKGROUND AND SUMMARY OF THE INVENTION

In this day, and age, of recycling, and a 24/7 workweek it is important for households to utilize their time and their resources wisely. Mundane tasks, such as laundry require the steps comprising of at least the following steps: sorting, organizing, washing and drying of items to be laundered including placement and folding of the garments and other items into a drawer or a container for access and use of the laundered items by the different members of the household.

The present invention provides a method or system comprising: a kit supplied to shorten, if not eliminate, the steps of the process of providing clean laundry as well as the organizing, the sorting, and the identification by a end user (normally members of the household) in a location where their clean laundered items are known to be found.

In addition, the present invention allows a user when laundering items to maintain the organization and sorting process previously completed, so when the washing and drying process is complete the user may place the laundered items in their desired end location, the use of the kit contents provided allows for this time saving step. The end user may repeat the process each time items must be laundered, the present inventive system then saves both time and money, as the laundered items (such as socks) stay paired, by having the sorting of items before laundering, the clean laundered items are readily available to conveniently place them back in the desired location for the end user's access and use.

The present invention provides for a kit, which includes instructions on developing a system of labels, which may be pre-labeled, attached to differently sized containers. The ease of identification by the coding of such labels or tags attached to the containers not only provides for easy identification of the items laundered, but also assures the items (especially where the items are paired) of being kept together. As the pairs of the items or garments are placed and maintained in the same container and are easily ascertainable as the container is clear, and can be seen through, and the containers are tagged with words or Braille so a blind person could use the inventive process, or worded for the color blind end user to utilize the process, and track and organize their garments as desired. Only an initial sorting may be required or necessary of the items to be laundered using this system. This is especially useful where items such as socks, which must be paired and properly matched for proper utilization by the end user. The tags or labels provided in the kit are attached to the containers, and aid the end user in the identification of the items laundered, and further provide the means in which a colorblind person or sightless person can identify the laundered item and its coloring.

For example, the colors of socks, or certain other items, can be difficult to distinguish especially when wet and the hue of the garment may appear different. The present invention solves this problem by keeping similar items paired, together, and identified. Therefore, the tags provide a method for colorblind users or blind users to identify their laundered items knowing the color, and the items are properly paired and together. By having the tags attached to the container the present invention further allows the laundered items to be coordinated for storing of the items by the user until the user is ready to wear the item. The user simply picks up the items by the container stored in the drawer, and knows the items have been properly paired and cleaned. No time is spent or wasted on having to match items, because the items have been easily identified for use.

A water insoluble marker memorializes the tags provided in the kit so a colorblind person can note the item and color. The tags can be either perforated, or provided with a material made out of PVC or other non-corrosive material, which may be “pushed out” by the marker so the sightless person can create a “marker” identifying the item by brail and the color of the item for easy identification.

Each item remains with its pair or sibling, as it is kept in the mesh container for ease of storage until use. After the items are used, they are placed back in a container for the next cleaning cycle. As noted below, socks provide a convenient example, as memorialized below to illustrate how the inventive system works. However, it should be noted the present invention is not limited to socks but may be used for most household garments, and provides a most convenient system for keeping items that require pairing together, such as gloves and socks (as noted).

The items in the kit can be used in any common washer or dryer since the items do not create any mechanical issues for the machines.

Further, the containers and tags are made out of a material impervious to the temperature of the water, detergents, and or bleach. The containers holding the items to be laundered are preferably made of a mesh material. A material such as mesh allows total exposure of the items to be laundered by detergents and/or bleach or other additives, such as softeners, allowing easy draining of the container(s).

Another key component of the invention is to keep paired items from being separated, especially items such as socks, which have a way of being separated and lost from their counterpart in either the washer or dryer or during sorting. Further, the containers allow the laundered items to be rinsed and spun without preventing the washer from draining the solution. I Items that assist in drying the garments may also be added to the dryer without disturbing the contents of the containers.

The invention can be made of different materials such as PVC, polypropylene; or other appropriate non-corrosive, lightweight material, which will keep the desired contents together. The preferred embodiment of the containers of the present invention is mesh. Other materials may be used if necessary, or desired, and the other materials can be made as porous as necessary should a stronger material be necessary to keep the intended laundered items together. For example, it may be desirable to have containers made of a thin PVC or polypropylene material, so items such as washable gym shoes where the insoles have been temporarily removed from the gym shoes for washing, are to be laundered. Several pairs of gym shoes or sneakers may be laundered at the same time since the washer or dryer will not be filled as if these items were loosely″ placed in the machine.

By tagging the containers, a count on not only the number of different types of items to be laundered is known, but also the number of each particular laundered item is maintained.

As an illustration, it may be desirable to have several containers made of mesh, or nylon fabric for socks. Whatever material the containers of the inventive process are made of, the items to be laundered can be bleached, exposed to any, and all types of detergents desired, and used in either hot or cold water.

An example, of a kit for socks, would include several mesh bags made of mesh nylon fabric, where the fabric may be bleached, in either hot or cold water, the mesh nylon bag, or container has no effect on the laundered item. The mesh nylon bag or container is also not altered by its exposure to the different cleaning elements.

As noted included in the kit is a marker, such as a Sharpie Rub-a-dub pen, providing for memorializing on a tab (2) attached to the container (1), or to be attached to the container the color of the item, the common term of the item (if desired) and the household member owning the item.

The pen or an attachment at the other end of the pen may be used to punch perforations in the tags or create a raised or puffed image on the tags to be attached to the mesh bags to provide for the identification of the information noted above. Where the household member in charge of the laundry is blind, the identification tag may come already marked in Braille, the additional tags along with the instrument at the end of the marking, provides the blind user with the ability to punch out the images or shapes denoting the contents in Braille.

The tags can then serve a dual function, besides providing the surface on which information is memorialized; the tags (2) can be attached to the mesh bags in such a manner as to provide a closure mechanism for the mesh bag(s). For example, the tag may contain a neck with a pair of arms or wings that slide over the two ends of the mesh bag or pouch to help lock the items to be laundered such as a pair of socks in the bag. Where the mesh bag or pouch has utilized a different type of closure mechanism the tag (2) can still be slid over the seal for added security of closure and to provide a strong enough attachment such that the tag will not become dislodged from the tag or container (1) during the cleaning process.

Closing mechanisms may include but are not limited to a string or zipper, elastic bands, or snaps. As noted, the tags may serve a dual function of acting as a lock to close the bag, or securing the contents to be laundered by acting as the primary locking mechanism. The tags may also only be used for identification purposes if desired. The tags can be sewn into the side of the mesh bags or other container, or have a mechanism by which they attach to said mesh bags or other container.

The kit will contain the appropriate amount of tags in coordination with the number of mesh bags or containers provided. The kits may be of different sizes and or quantities depending on the number of family members and the different sizes of the items desired to be laundered.

For example, 14 mesh bags may be provided for each member of the family Thus for a family of four, 56 mesh bags would be provided along with the marker. The kit would contain mesh bags of differing sizes where the household would have children as part of the household. The mesh bags would not only keep differing sizes of clothing together, but upon completion of the washing (4) and drying cycle (5), provide a convenient method of placing the laundered items in the appropriate household member's drawer (6) and also be easily identified by owner and color

Members of the household would no longer find it necessary to “pair” their socks after washing and drying. An end user having worn a pair of socks would place the items in the container (1) such as a mesh bag, so the family member in charge of laundering such items would then obtain the socks or other item to be laundered in the container and the items are now already sorted and are obtained from a designated spot (3) where the items to be laundered are placed. The items after being laundered would stay in place, and the mesh bag or other container can be returned to its designated place (6). Therefore, the cycle may start anew. In addition, by having household members return their socks (or other garments) to the container, the socks do not become separated and lost.

The household member in charge of doing the laundry does not need to spend time on sorting the socks or other laundry items once cleaned, since this has already been done by the present inventive process and is maintained by the items provided in the kit. As a result, the household member saves time, because they can again place the mesh bag or container in the designated storage unit or area for easy identification, and use and place the items back in the washer for cleaning of the garments.

The cycle repeats itself. The cycle will repeat itself until the garment requires replacement, or the household member desires to replace the item, the sock or garment is replaced then, not because it is lost, but because of other circumstances such as the sock becoming worn out or the household member has outgrown or wishes to replace the socks.

Time formally spent sorting garments before washing is eliminated because the user can place laundered items in the dresser immediately out of the dryer. Sorting and folding are not necessary. Time formally spent sorting and folding after drying is eliminated. Time formally spent looking for missing garments is eliminated. Time identifying whom the garment belongs to is a household of more than one is eliminated. Errors wearing the wrong color of sock are halted. Finally, money spent replacing lost garments is saved. Another object of the invention, is provide a kit that is inexpensive, while in this day and age of technology, machine readers, and electronic tags can be utilized, the present invention provides for an inexpensive kit that does not require machine readers or controllers to do the laundry. Folding and sorting are no longer necessary as the user can place the laundered items in the containers back in their dresser for wearing the next time they desire. No special ingredients are required, and the items can be laundered as they normally are, and therefore no special equipment or machinery is necessary.

Many organizing and sorting systems have been developed over the past several years. The instructions in the kit provided will offer the household member in charge of the laundry a couple of proven methods in terms of identification, marking, sorting and storing the items to be laundered. The buyer will also have the opportunity to adjust the system, as they deem appropriate, for their own needs. As noted, the kit will supply all the essential materials necessary to utilize the method memorialized above. Therefore, the present invention will provide enough flexibility so that any given household may slightly alter the system and still reap the benefits of the invention, while fitting their own needs.

The kit then contains at least the following items:

A marker and or mechanism to perforate or raise the images on the tags for identification purposes;

A sufficient number of tags, to be provided by the number of containers supplied in the kit;

The tags can be preprinted so word, colors, images, or any desired designation may be used and readily available.

The tags can come in the kit already attached to the containers.
The tags themselves can have an attachment means to connect to the mesh bags or containers for identification purposes and if desired to act as a seal of the container; and a set of instructions defining a system or method of how a purchaser or user desires to label the tags, and attach them to the containers so the purchaser or user is able to see the pairing and identification of the items to be laundered, whereby after the initial sorting of items, the non-necessity of having to sort and fold such items.

A systematic method for the identification of items to be laundered, where the inventive process includes the maintenance of the items after the initial organizing, sorting, and placement of such items into designated holders or containers.

### BRIEF DESCRIPTION OF THE DRAWINGS

FIG. 1 is a perspective view of the container where the closing mechanism is a zipper.

FIG. 1A is a perspective view of the container where the closing mechanism is snaps.

FIG. 2 is an illustration of the inventive process where the containers are placed in the designated spot to be laundered, laundered, and returned to their desired location.

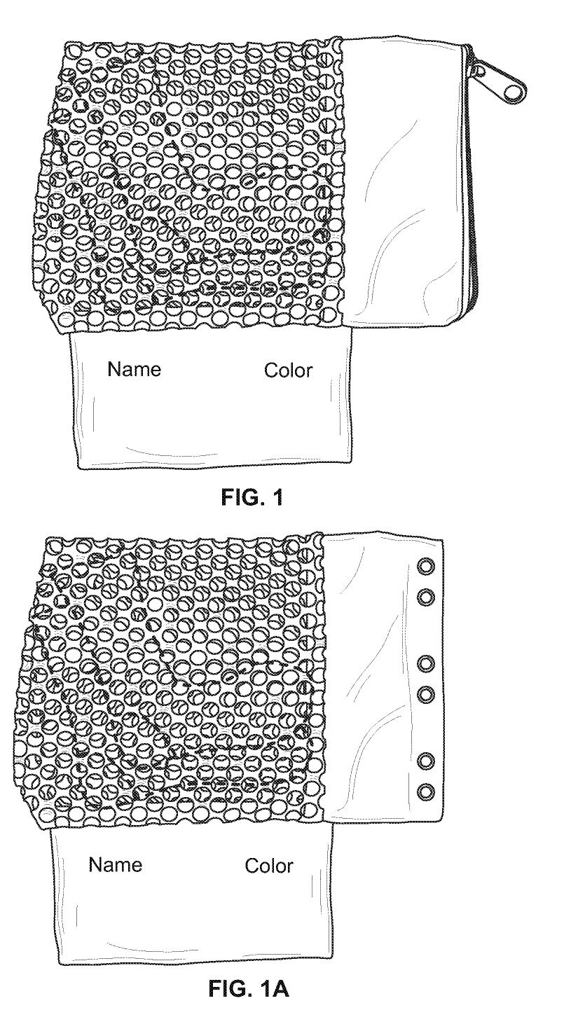

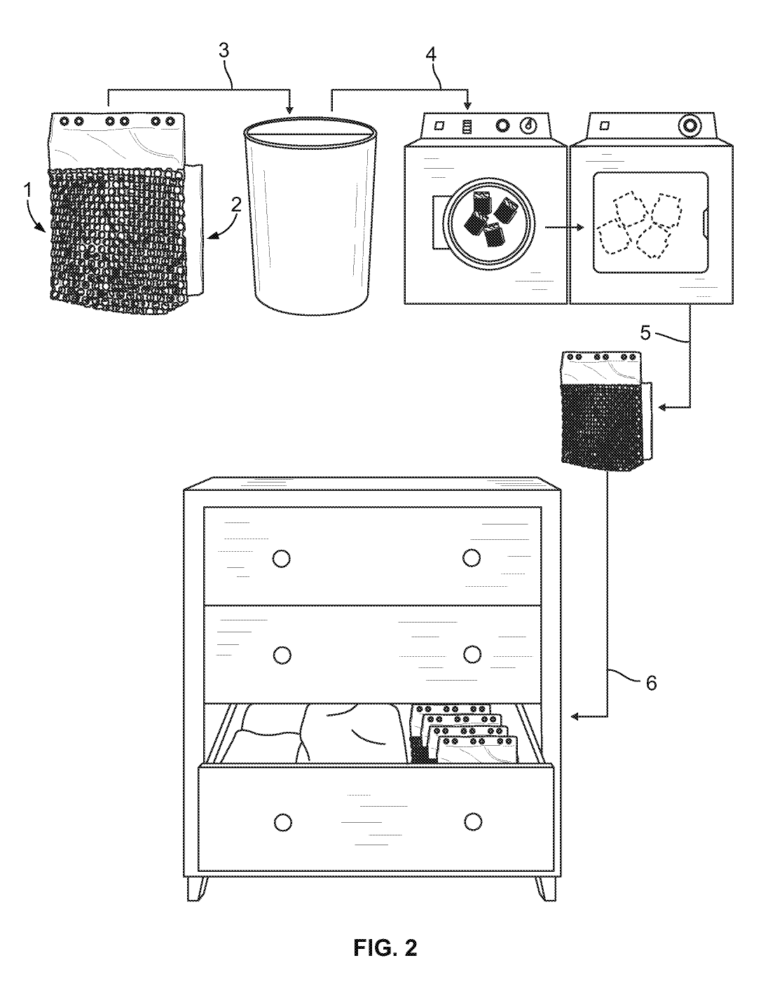

I claim:

1. A method and identification of items to be laundered, organized, sorted, and placed into designated holders comprising:
a. A kit comprising:
1. Instructions on developing a system of a plurality of labels or tags; and/or pre-labels or tags to be attached to a plurality of containers for identifying a plurality of items to be laundered, and said tags or label container a closure mechanism;
2. A plurality of containers sized for laundering items;
3. said containers being clear or transparent;
4. said containers can be tagged with words or Braille;
5. a water insoluble marking instrument for marking said labels or tags;
6. marking said labels if necessary, with said marking instrument;
7. Said containers being made of mesh or other material impervious to the temperature of the water, washing detergents, and bleach;
8. Said containers provide the laundered items within to be rinsed and spun without preventing the water from draining;
9. Said containers provide a barrier for the garments when items assisted in drying the garments are added to a dryer
10. Said contents of the containers are not disturbed.
b. Initially sorting the laundered item to be clean;
c. The initial sorting of the laundered items by size for placement into said containers;
d. The labels or pre-labels containing said identifiers to identify the item to be cleaned and its coloring; and
e. Storing said laundered item in a known location.

2. The tags of claim 1 where said tags can be perforated.

3. The tags of claim 1 where said tags are made of a material such as PVC, polypropylene, or other non-corrosive lightweight material.

4. The tags of claim may consisted of indentations to be “pushed out” by a marker or other device, so a sightless person can create a marker by which the person or user can identify the item and color of the items stored in said containers.

5. The containers of claim 1 where said containers are made of mesh.

6. The containers of claim 1 where said containers are made of a lightweight non-soluble, non-corrosive see through material, such as a nylon fabric, and where detergents or bleach does not corrupt said material of the container.

7. The marking instrument of claim 1, where said marking instrument is a Sharpie Rub-a-dub pen.

8. The marking instrument of claim 1 where the marking instrument is a magic marker.

9. The marking instrument of claim 1 where one end of said marking instrument is made for marking and a second end or opposite end of said marking instrument has an attachment to punch or raise perforations on said tags connected to said containers.

10. The labels or tags of claim 1 attached to said containers having or containing a closure mechanism for said paired container.

11. The closure mechanism of claim 1 is a zipper.

12. The closure mechanism of claim 1 is made of Velcro.

13. The closure mechanism of claim 1 is a plurality of snaps.

14. The closure mechanism of claim 1 attached to the container having a neck with a pair of arms or wings that slide over the two ends of the container to help lock the items to be laundered.

15. The closure mechanism of claim 1 is a string.

16. The kit of claim having a plurality of tags to be provided for the number of containers supplied is said kit.

17. A set of instructions defining a system or method of how the purchaser or user may desire to label said tags and said tags to said containers so the user is able to see the pairing and identification of said items to be laundered.

18. A systematic method for the identification of items to be laundered, where the inventive process includes the maintenance of the items after the initial organizing, sorting, and placement of said items into designated holders or containers.
